(19) United States
(12) Patent Application Publication
(10) Pub. No.: US 2025/0303875 A1
(43) Pub. Date: Oct. 2, 2025

(54) Method, Device, Controller and Computer Program Product for Comfortable Braking

(71) Applicant: Robert Bosch GmbH, Stuttgart (DE)

(72) Inventor: Renrui Wang, Suzhou (CN)

(21) Appl. No.: 19/087,491

(22) Filed: Mar. 22, 2025

(30) Foreign Application Priority Data
Mar. 27, 2024 (CN) 2024 1036 4901.2

(51) Int. Cl. B60L 7/26

(52) U.S. Cl. CPC B60L 7/26; B60L 2240/12; B60L 2240/16; B60L 2240/42; B60L 2240/642; B60L 2250/26

(57) ABSTRACT

A method, a device, a controller and a computer program product for comfortable braking are disclosed. The method includes (i) determining a comfortable braking force based on an opening degree of a brake pedal of a vehicle, (ii) determining a hydraulic braking force and a regenerative braking force based on the comfortable braking force, and (iii) performing comfortable braking on the vehicle based on the hydraulic braking force and the regenerative braking force. By way of the above, the comfortable braking function may be realized in a coupled braking system. By simultaneously utilizing the hydraulic braking force and the regenerative braking force for comfortable braking, the braking performance of the vehicle is improved, the braking process is made smoother and more comfortable, and the driving experience of a driver and passengers is improved.

This application claims priority under 35 U.S.C. § 119 to application no. CN 2024 1036 4901.2, filed on Mar. 27, 2024 in China, the disclosure of which is incorporated herein by reference in its entirety.

Examples of the present disclosure relate to the field of computers, and more particularly, to a method, a device, a controller and a computer program product for comfortable braking.

### BACKGROUND

Traditional braking systems may lead to noticeable nodding and vibration while braking, resulting in an unpleasant experience for both drivers and passengers. In contrast, the comfortable braking technology delivers a smooth braking experience through intelligent control and optimized design. This technology not only enhances braking comfort and significantly improves the driving experience, but also reduces wear on the braking system, extending the lifespan of its components.

The comfortable braking technology has become increasingly vital in the modern automotive industry, and its application has become a key trend in the development of the industry. With the ongoing enhancement of driving experience and ride comfort, the widespread adoption of the comfortable braking technology has emerged as an essential innovation that automobile manufacturers cannot overlook. In scenarios like congested urban traffic or long-distance travel, the comfortable braking technology has become a crucial way to enhance the driving experience for both drivers and passengers.

### SUMMARY

Examples of the present disclosure provide a method, a device, a controller, a computer program product, and a medium for comfortable braking.

According to the first aspect of the present disclosure, a method for comfortable braking is provided. The method comprises determining a comfortable braking force based on an opening degree of a brake pedal of a vehicle. The method further comprises determining a hydraulic braking force and a regenerative braking force based on the comfortable braking force. In addition, the method further comprises performing comfortable braking on the vehicle based on the hydraulic braking force and the regenerative braking force.

According to the second aspect of the present disclosure, a device for comfortable braking is provided. The device comprises a comfortable braking determination unit, configured to determine a comfortable braking force based on an opening degree of a brake pedal of a vehicle. The device further comprises a hydraulic regeneration determination unit, configured to determine a hydraulic braking force and a regenerative braking force based on the comfortable braking force. In addition, the device further comprises a comfortable braking control unit, configured to perform comfortable braking on the vehicle based on the hydraulic braking force and the regenerative braking force.

According to the third aspect of the present disclosure, a controller is provided. The controller comprises at least one processor, and a memory coupled to the at least one processor and having instructions stored thereon, wherein the instructions, when executed by the at least one processor, cause the controller to perform the steps of the method of the first aspect of the present disclosure.

According to the fourth aspect of the present disclosure, a computer program product is provided. The computer program product is tangibly stored on a non-transitory computer-readable medium and comprising computer-executable instructions, wherein the computer-executable instructions, when executed, cause the computer to perform the steps of the method of the first aspect of the present disclosure.

According to the fifth aspect of the present disclosure, a machine-readable storage medium is provided. The machine-readable storage medium stores machine-executable instructions, wherein the machine-executable instructions are executed by a processor to perform the steps of the method of the first aspect of the present disclosure.

### BRIEF DESCRIPTION OF THE DRAWINGS

The exemplary examples of the present disclosure will be described in further detail in conjunction with the drawings in order to further clarify the above-mentioned and other objectives, features and advantages of the present disclosure, wherein in the exemplary examples of the present disclosure, the same reference number typically represents the same parts.

FIG. 1 is a schematic diagram of an exemplary environment in which the controller and/or method according to examples of the present disclosure may be implemented;

FIG. 2 is a flow chart of a method for comfortable braking according to examples of the present disclosure;

FIG. 3 is a flow chart of a process for distributing braking force according to examples of the present disclosure;

FIG. 4A is a flow chart of a process for realizing full-performance comfortable braking according to examples of the present disclosure;

FIG. 4B is a schematic diagram showing braking force changes for realizing full-performance comfortable braking according to examples of the present disclosure;

FIG. 5A is a flow chart of a process for realizing reduced-performance comfortable braking according to examples of the present disclosure;

FIG. 5B is a schematic diagram showing braking force changes for realizing reduced-performance comfortable braking according to examples of the present disclosure;

FIG. 6 is a flow chart of a process for determining a regenerative braking force according to examples of the present disclosure;

FIG. 7 is a schematic diagram of a device for comfortable braking according to examples of the present disclosure; and

FIG. 8 is a schematic block diagram of an exemplary device suitable for implementing examples of the present disclosure.

In the various drawings, the same or corresponding numbers represent the same or corresponding parts.

### DETAILED DESCRIPTION

The examples of the present disclosure will be described in further detail below with reference to the drawings. While certain examples of the present disclosure are shown in the drawings, it should be understood that the present disclosure may be implemented in various forms and should not be construed as being limited to the examples set forth herein, rather these examples are provided for a more thorough and complete understanding of the present disclosure.

As mentioned above, the application of the comfortable braking technology is becoming more and more widespread, which may bring a comfortable driving experience to drivers and passengers. However, the existing comfortable braking technology is usually applied in decoupled braking systems, but not in coupled braking systems. The brake pedal and hydraulic braking force are coupled to each other in coupled braking systems. In a decoupled braking system, when the driver depresses the brake pedal, the braking system converts the brake signal into an electrical signal, which is then processed by the motor controller to engage the brakes. This eliminates the need for physical connections like hydraulics, allowing for easy adjustments of the braking force to realize comfortable braking. In a coupled braking system, when the driver depresses the brake pedal, the piston in the reservoir moves outward, causing brake fluid to flow into the master cylinder and generating hydraulic braking force. However, in comfortable braking scenarios, drivers often do not actively release the brake pedal, preventing brake fluid from flowing back from the brake wheel cylinder to the brake master cylinder. As a result, the hydraulic braking force cannot be reduced, making it inconvenient to adjust the system for comfortable braking.

To address this, the examples of the present disclosure propose a solution of comfortable braking that leverages both hydraulic braking force and regenerative braking force. This solution first determines the comfortable braking force based on an opening degree of a brake pedal of the vehicle, and allocates hydraulic braking force and regenerative braking force according to this established comfortable braking force. It then utilizes the hydraulic braking force and the regenerative braking force to perform comfortable braking on the vehicle. Therefore, according to the solution of the examples of the present disclosure, the comfortable braking function may be realized in a coupled braking system. By simultaneously utilizing the hydraulic braking force and the regenerative braking force for comfortable braking, the braking performance of the vehicle is improved, the braking process is made smoother and more comfortable, and the driving experience of a driver and passengers is improved.

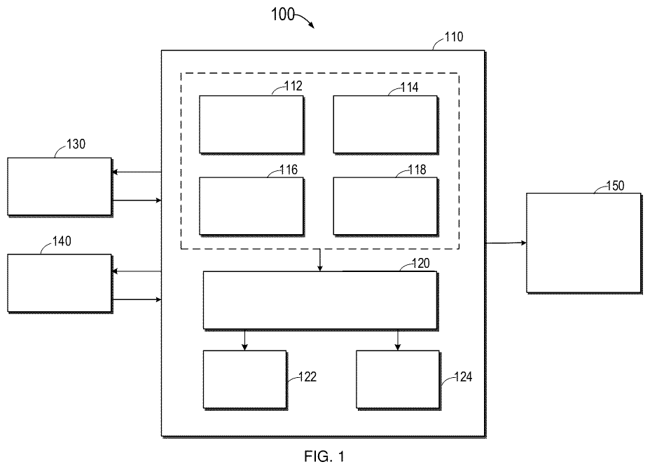

Examples of the present disclosure will be described in further detail below in conjunction with the drawings, wherein FIG. 1 illustrates an exemplary environment 100 in which the controller and/or method according to the examples of the present disclosure may be implemented.

As shown in FIG. 1, the exemplary environment 100 comprises a control system 110, which may determine whether comfortable braking can be triggered, and may determine how to allocate hydraulic braking force and regenerative braking force, etc. The control system 110 may be deployed on a vehicle or on a domain controller, and may communicate with other controllers of the vehicle through a vehicle bus communication connection, which is not limited by the present disclosure. In addition, when the control system 110 is deployed on the domain controller, it may communicate with sensors through the vehicle bus communication connection to obtain corresponding sensor data. The control system 110 may comprise an acceleration sensor 112, and may obtain the acceleration of the vehicle when moving forward and the deceleration when braking through the acceleration sensor 112. In some examples, whether to trigger the comfortable braking function may be determined by the magnitude of the vehicle's deceleration. In addition, the control system 110 may also communicate with sensors through the vehicle bus to obtain corresponding sensor data. The control system 110 may also comprise a brake pedal sensor 114, through which the current opening degree of the brake pedal, that is, the travel of the brake pedal being depressed by the driver, may be obtained, and the target braking force requested by the driver may be determined based on the opening degree value. When the driver depresses the brake pedal, an electronic booster can push the piston in the brake master cylinder forward, pushing the brake fluid into the brake wheel cylinder to achieve hydraulic braking. Consequently, the more the driver depresses the brake pedal, the more brake fluid is pushed into the brake master cylinder, and the greater the hydraulic braking force is requested.

Continuing with reference to FIG. 1, the control system 110 may further comprise a speed sensor 116 that can obtain the current speed of the vehicle. In some examples, the current speed of the vehicle may be considered when determining whether to trigger the comfortable braking function or calculate the comfortable braking force. For example, when the vehicle is braking normally and its speed remains above the threshold for triggering comfortable braking, the comfortable braking will not be triggered. In addition, the braking force of the front and rear axles may be distributed based on the speed to further improve the comfort of the comfortable braking. For example, the braking pressure of the front axle may be reduced in the late stage of braking (e.g., speed <2 km/h). The control system 110 may further comprise a slope sensor 118 that can obtain the current slope value of the vehicle. In some examples, the vehicle may not comprise the slope sensor 118, but the slope information may be estimated based on other sensor information to generate a slope estimation value. In some examples, when the vehicle is on a slope, the required braking force and the comfortable braking force may change, and the control system 110 may use the parameters of the slope value or the slope estimation value when determining the comfortable braking force. It should be understood that the control system may further comprise other sensors or may obtain other vehicle parameters. For example, the control system may further comprise a brake pedal speed sensor that measures the speed value at which the driver depresses the brake pedal, allowing for an analysis of the driver's braking intentions. For example, when the driver quickly depresses the brake pedal, it can be determined that the vehicle is in an emergency braking condition, and the comfortable braking function is not triggered at this time. In order to ensure the stability of vehicle braking, the regenerative braking force can be reduced and the corresponding hydraulic braking force can be increased.

Continuing with reference to FIG. 1, the control system 110 may further comprise a controller 120, which may calculate the comfortable braking force based on the current state parameters of the vehicle. For example, the controller 120 may obtain the magnitude of the vehicle's deceleration from the acceleration sensor 112, the opening degree of the brake pedal from the brake pedal sensor 114, the vehicle's speed from the speed sensor 116, and the vehicle's slope value or slope estimation value from the slope sensor 118, and calculate the magnitude of the comfortable braking force based on these parameters. In some examples, the comfortable braking force may also be calculated using parameters such as the vehicle mass, the wheel rolling radius, and the front and rear wheelbase. In some examples, machine learning and/or deep learning models may be used to process the parameters of the vehicle to calculate the comfortable braking force. The controller 120 may determine hydraulic braking force 122 and regenerative braking force 124 according to the comfortable braking force. For example, the controller 120 may allocate a portion of the comfortable braking force as the hydraulic braking force 122 and another portion as the regenerative braking force 124. In addition, the controller 120 may also send an activation flag for the comfortable braking to a vehicle control unit 150 to indicate to the vehicle control unit 150 whether to trigger the comfortable braking.

As shown in FIG. 1, the exemplary environment 100 may comprise a hydraulic brake unit 130. The control system 110 may request the target hydraulic braking force from the hydraulic brake unit 130, and the hydraulic brake unit 130 may send the actual hydraulic braking force to the control system 110. For example, the control system 110 may request a hydraulic braking force of 200 N from the hydraulic brake unit 130, but since the hydraulic braking force at the previous moment has reached 300 N, the coupled brake system cannot reduce the hydraulic braking force when the driver maintains the opening degree of the brake pedal, therefore the hydraulic braking force actually generated by the hydraulic brake unit 130 is 300 N. For example, the control system 110 may request a hydraulic braking force of 200 N from the hydraulic brake unit 130, but since the hydraulic braking force at the previous moment is less than 200 N, the hydraulic brake unit 130 may send the actual hydraulic braking force to the control system 110. In addition, the control system 110 may also request the hydraulic brake unit 130 to adjust the current hydraulic braking force for use in the braking force distribution process.

The exemplary environment 100 may further comprise a regenerative braking unit 140. Regenerative braking is a braking technology used in electric vehicles that converts and stores the vehicle's kinetic energy during braking. Specifically, regenerative braking transitions the motor into generator mode during braking, utilizing the vehicle's inertia to rotate the motor rotor and create reverse torque for braking. When the brake pedal is not depressed, energy recovery is achieved by merely releasing the accelerator pedal, a process known as coasting energy recovery. This coasting regeneration (also known as sliding energy recovery) occurs when the vehicle is traveling at a certain speed; upon releasing the accelerator pedal by the driver, the motor shifts from providing driving torque to generating feedback braking torque. This transition creates regenerative braking force, resulting in braking deceleration for the entire vehicle. The operating condition for braking regeneration (braking energy recovery) occurs when the brake pedal is depressed, causing the motor to provide braking torque and generate regenerative braking force. In some examples, the control system 110 may request the regenerative braking force from the regenerative braking unit 140, and the regenerative braking unit 140 may send the actual regenerative braking force that can be provided to the control system 110. For example, when the comfortable braking force is determined to be 500 N, the regenerative braking force that the regenerative braking unit 140 can provide may be determined based on the potential of the regenerative braking unit 140, and its magnitude is related to parameters such as the recovery power of the motor, the battery capacity, and the current vehicle's speed. When the comfortable braking force is determined to be 500 N, the regenerative braking unit 140 may send a message to the control system 110 that the actual achievable regenerative braking force is 500 N, therefore no hydraulic braking force is needed for supplementation; it can also send a message to the control system 110 that the actual achievable regenerative braking force is 400 N, therefore 100 N of hydraulic braking force needs to be supplemented.

Referring to FIG. 1, the exemplary environment 100 may comprise a vehicle control unit 150. The vehicle control unit 150 may receive an activation flag of the comfortable brake from the control system 110, thereby possibly adjusting its control strategy to ensure that the entire vehicle system can be coordinated accordingly when the comfortable brake is activated. In addition, the vehicle control unit 150 may also monitor both the hydraulic braking force 122 and the regenerative braking force 124. When there is a rapid change in the regenerative braking force 124, the hydraulic braking force 122 is promptly adjusted to compensate.

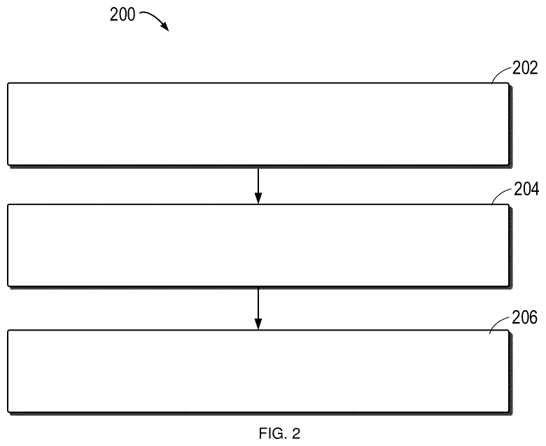

The above, in conjunction with FIG. 1, describes the exemplary environment 100 in which the examples of the present disclosure may be implemented. A flowchart of a method 200 for comfortable braking force according to examples of the present disclosure is described below in conjunction with FIG. 2.

FIG. 2 is a flow chart of a method 200 for comfortable braking according to examples of the present disclosure. At block 202, the comfortable braking force may be determined based on the opening degree of the brake pedal of the vehicle. For example, as described in conjunction with FIG. 1, the controller 120 may determine the comfortable braking force based on the opening degree value from the brake pedal sensor 114. The opening degree refers to how deeply the brake pedal is depressed, that is, the degree to which the driver depresses the brake pedal. If the opening degree of the brake pedal is small, the system may apply a gentler comfortable braking force to ensure a smooth braking process. Conversely, if the opening degree is large, the system may provide a stronger comfortable braking force to meet more urgent braking requirements.

At block 204, the hydraulic braking force and the regenerative braking force may be determined based on the comfortable braking force. For example, in conjunction with FIG. 1, the controller 120 may determine the hydraulic braking force 122 and the regenerative braking force 124 based on the comfortable braking force. The hydraulic braking force is achieved by a hydraulic braking system, and the magnitude of the hydraulic braking force may be determined by the controller 120 based on the minimum value of the comfortable braking force. The regenerative braking force is generated by switching the motor to generator and utilizing the vehicle's inertia to rotate the motor rotor. The magnitude of the regenerative braking force may be determined by the controller 120 based on the comfortable braking force.

At block 206, the hydraulic braking force and the regenerative braking force may be used to perform comfortable braking for the vehicle. For example, as described in conjunction with FIG. 1, the controller 110 may use the hydraulic braking force 122 and the regenerative braking force 124 to perform comfortable braking for the vehicle.

Therefore, according to the method 200 provided in the examples of the present disclosure, the comfortable braking function may be realized in a coupled braking system. By simultaneously utilizing the hydraulic braking force and the regenerative braking force for comfortable braking, the braking performance of the vehicle is improved, the braking process is made smoother and more comfortable, and the driving experience of a driver and passengers is improved.

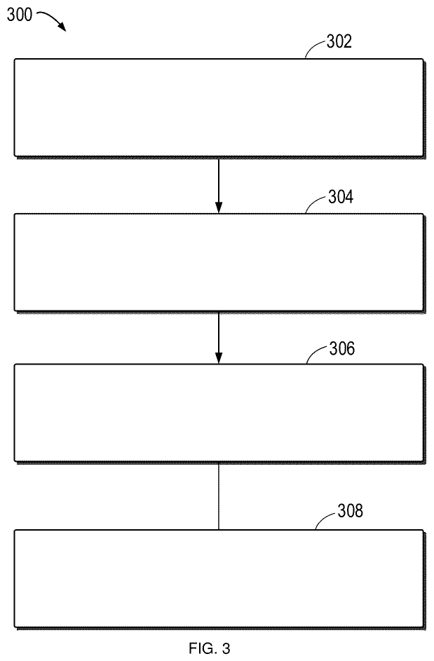

FIG. 3 is a flow chart of a process 300 for distributing braking force according to examples of the present disclosure. At block 302, the current hydraulic braking force may be obtained. For example, in conjunction with FIG. 1, the control system 110 may obtain the current hydraulic braking force from the hydraulic brake unit 140. In some examples, the control system may obtain the current hydraulic braking force from the vehicle control unit. As described above, when the driver maintains the opening degree of the brake pedal, the coupled brake system cannot reduce the hydraulic braking force, therefore the actual hydraulic braking force generated by the hydraulic brake unit will not be less than the current hydraulic braking force.

At block 304, the target regenerative braking force may be determined based on the comfortable braking force and the current hydraulic braking force. In some examples, the target braking force that the driver wants to request may be determined by the opening degree of the brake pedal, and then the comfortable braking force may be determined based on parameters such as the target braking force, vehicle's speed, deceleration, and slope value. For example, if the comfortable braking force may be determined to be 500 N, and the current hydraulic braking force is detected to be 100 N, then the target regenerative braking force may be determined to be 400 N. Since regenerative braking enables energy recovery, increasing the proportion of regenerative braking may enhance the energy recovery efficiency during braking.

At block 306, the target regenerative braking force may be requested from the regenerative braking unit, and the actual regenerative braking force may be determined. For example, if a braking force of 400 N may be requested from the regenerative braking unit, various parameters such as vehicle's speed, motor power, and battery capacity may indicate that the maximum achievable regenerative braking force is 300 N. In this case, the actual regenerative braking force will be 300 N. In other words, when the target regenerative braking force is greater than the maximum regenerative braking force that can be provided by the regenerative braking unit, the magnitude of the actual regenerative braking force is equal to the maximum regenerative braking force. In addition, in some examples, if a target regenerative braking force of 400 N may be requested from the regenerative braking unit, and it is determined that the maximum achievable regenerative braking force is 800 N, then the actual regenerative braking force will be 400 N. In other words, when the target regenerative braking force is less than the maximum regenerative braking force that can be provided by the regenerative braking unit, the magnitude of the actual regenerative braking force is equal to the target regenerative braking force.

At block 308, the actual hydraulic braking force can be determined based on the comfortable braking force and the actual regenerative braking force. For example, when the comfortable braking force is 500 N and the actual regenerative braking force that can be provided by the regenerative braking unit is 300 N, the actual hydraulic braking force may be adjusted to 200 N so that the actual regenerative braking force and the actual hydraulic braking force meet the comfortable braking force. In addition, in some examples, when the actual regenerative braking force is the same as the target regenerative braking force, there is no need to adjust the hydraulic braking force. For example, if the actual regenerative braking force that can be provided by the regenerative braking unit is 400 N, the actual hydraulic braking force may be determined to be 100 N, meaning the current hydraulic braking force remains unchanged at 100 N. In some examples, when an increase in hydraulic braking force is required, the braking force may be directed into the brake master cylinder by adjusting its magnitude accordingly.

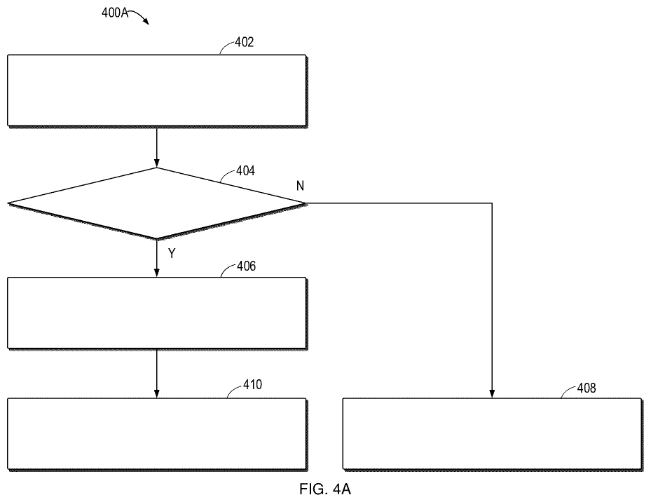

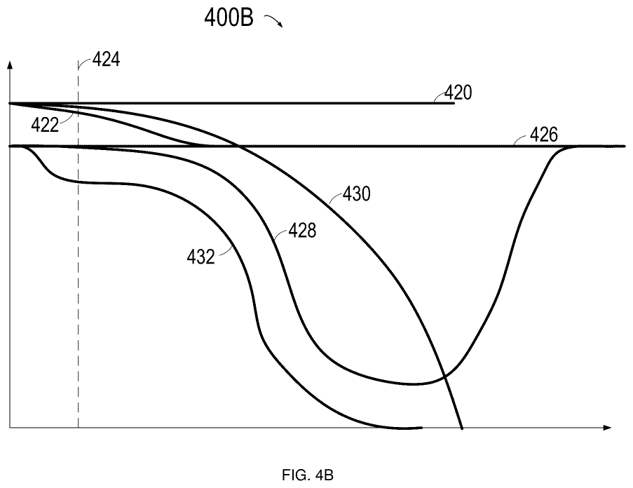

FIG. 4A is a flow chart of a process 400 for realizing full-performance comfortable braking according to examples of the present disclosure, and FIG. 4B is a schematic diagram 400B of braking force changes for realizing full-performance comfortable braking according to examples of the present disclosure. The process of full-performance comfortable braking will be described below in conjunction with FIG. 4A and FIG. 4B. At block 402, the current hydraulic braking force may be obtained. For example, in conjunction with FIG. 1, the control system 110 may obtain the current hydraulic braking force from the hydraulic brake unit 140. In some examples, the control system may obtain the current hydraulic braking force from the vehicle control unit. As previously described, since the requested target hydraulic braking force cannot be less than the current hydraulic braking force, it is necessary to determine the magnitude of the current hydraulic braking force.

As shown in FIG. 4A, at block 404, it may be determined whether the current hydraulic braking force is less than the minimum value of the comfortable braking force. In some examples, the minimum value of the comfortable braking force may be determined based on parameters such as vehicle's speed, deceleration, and slope value. For example, if the minimum value of the comfortable braking force is determined to be 500 N, and the current hydraulic braking force is 300 N, since the current hydraulic braking force is less than the minimum value of the comfortable braking force, full-performance comfortable braking may be triggered by adjusting the hydraulic braking force and the regenerative braking force at the same time. For another example, when the minimum value of the comfortable braking force is determined to be 500 N, and the current hydraulic braking force is 800 N, since the current hydraulic braking force is greater than the minimum value of the comfortable braking force, full-performance comfortable braking cannot be realized even if the regenerative braking force is adjusted to zero.

When it is determined in block 404 that the current hydraulic braking force is less than the minimum value of the comfortable braking force, the process proceeds to block 406 to trigger the full-performance comfortable braking. Otherwise, the process proceeds to block 408 to conclude that the full-performance comfortable braking cannot be triggered. At block 406, the target hydraulic braking force and the target regenerative braking force may be determined based on the current hydraulic braking force. For example, as described in conjunction with FIG. 3, the regenerative braking force may be adjusted according to the comfortable braking force and the current hydraulic braking force to realize the full-performance comfortable braking.

The following describes the process of braking force changes for the full-performance comfortable braking force in conjunction with FIG. 4B. As shown in FIG. 4B, straight line 420 represents the coasting regeneration request. As mentioned above, coasting regeneration is a part of regenerative braking. When the driver releases the accelerator pedal and does not step on the brake pedal, the coasting regeneration request is triggered. Curve 422 represents the comfortable regenerative braking force request corresponding to the coasting regeneration request. Dashed line 424 marks the beginning of comfortable braking. It is evident that with the intervention of comfortable braking, curve 422 gradually diminishes, indicating that the regenerative braking force corresponding to the coasting regeneration request slowly approaches zero. Straight line 426 represents the target braking force requested by the driver, while curve 428 illustrates the comfortable braking force. It is evident that the comfortable braking force is less than the target braking force, which minimizes the impact during the braking process and facilitates a more comfortable braking experience. In addition, curve 430 represents the motor regeneration potential, and curve 432 represents the comfortable regenerative braking force corresponding to the comfortable braking force generated when the driver steps on the brake pedal. The portion between curve 428 and curve 432 represents the target magnitude of the comfortable hydraulic braking force. It can be seen that the comfortable braking force is composed of the comfortable braking pressure and the comfortable regenerative braking force. With the intervention of the comfortable braking, the regenerative braking force will gradually decrease and eventually cease, while the comfort hydraulic braking force will remain unchanged. Consequently, as the regenerative braking force diminishes, the comfortable braking force will progressively align with the comfortable hydraulic braking force. When the vehicle stops, the hydraulic braking force can be increased be consistent with the target braking force requested by the driver.

Referring back to FIG. 4A, at block 410, a full-performance indicator may be sent to the vehicle control unit. For example, by offering real-time feedback on the performance of comfortable braking, the driver is kept informed about the vehicle's braking capabilities, allowing other systems to adjust in accordance with the level of comfortable braking performance. In addition, in some examples, whether to trigger full-performance comfortable braking may be based on whether the current deceleration falls below the deceleration threshold. For example, assuming that the deceleration threshold is 3 m/s² and the current deceleration is less than the deceleration threshold, it is determined that the full-performance comfortable braking may be triggered.

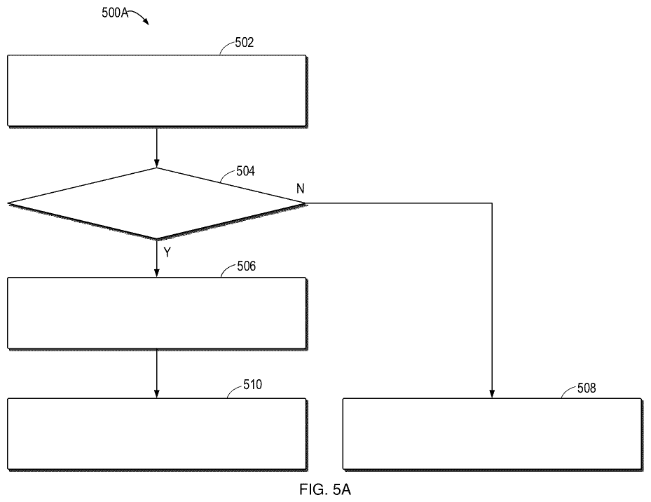

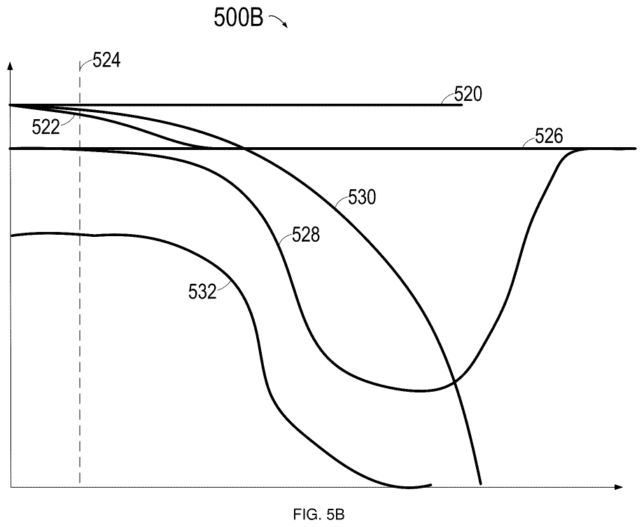

FIG. 5A is a flow chart of a process 500 for realizing reduced-performance comfortable braking according to examples of the present disclosure, and FIG. 5B is a schematic diagram 500B of braking force changes for realizing reduced-performance comfortable braking according to examples of the present disclosure. The process of reduced-performance comfortable braking will be described below in conjunction with FIG. 5A and FIG. 5B. As shown in FIG. 5A, at block 502, the current hydraulic braking force may be acquired. For example, in conjunction with FIG. 1, the control system 110 may obtain the current hydraulic braking force from the hydraulic brake unit 140. In some examples, the control system may obtain the current hydraulic braking force from the vehicle control unit.

At block 504, it can be determined whether the current hydraulic braking force is greater than the minimum value of the comfortable braking force and less than the target braking force. In some examples, the minimum value of the comfortable braking force may be determined based on parameters such as vehicle's speed, deceleration, and slope value. For another example, when the target braking force is determined to be 1000 N and the minimum value of the comfortable braking force is 500 N, and the current hydraulic braking force is 800 N, since the current hydraulic braking force is greater than the minimum value of the comfortable braking force, full-performance comfortable braking cannot be realized even if the regenerative braking force is adjusted to zero. However, it is feasible to perform reduced-performance comfortable braking with a current hydraulic braking force of 800 N. This is because compared to the target braking force of 1000 N requested by the driver, utilizing a hydraulic braking force of 800 N can still help reduce the impact of the braking process to some extent and enhance the driver's overall braking comfort.

When it is determined in block 504 that the current hydraulic braking force is greater than the minimum value of the comfortable braking force and less than the target braking force, the process proceeds to block 506 to trigger the reduced-performance comfortable braking. Otherwise, the process proceeds to block 508 to conclude that the reduced-performance comfortable braking cannot be triggered. At block 506, the target hydraulic braking force and the target regenerative braking force may be determined based on the current hydraulic braking force. For example, as described in conjunction with FIG. 3, the target regenerative braking force may be determined according to the comfortable braking force and the current hydraulic braking force, and the target hydraulic braking force may be further determined to realize the reduced-performance comfortable braking.

The following describes the process of braking force changes for the reduced-performance comfortable braking force in conjunction with FIG. 5B. As shown in FIG. 5B, straight line 520 represents the coasting regeneration request, and curve 522 represents the comfortable regenerative braking force corresponding to the coasting regeneration request. Dashed line 524 marks the beginning of comfortable braking. It is evident that with the intervention of comfortable braking, curve 522 gradually diminishes, indicating that the comfortable regenerative braking force corresponding to the coasting regeneration request slowly approaches zero. Straight line 526 represents the target braking force requested by the driver, while curve 528 illustrates the comfortable braking force. It is evident that the comfortable braking force is less than the target braking force, which minimizes the impact during the braking process and facilitates a more comfortable braking experience. In addition, curve 530 represents the motor regeneration potential, and curve 532 represents the regenerative braking force corresponding to the brake regeneration request generated when the driver steps on the brake pedal. The portion between curve 528 and curve 532 represents the magnitude of the actual hydraulic braking force. Compared to the process shown in FIG. 4B, the hydraulic braking force shown in FIG. 5B is larger, and since it cannot be adjusted to be less than the comfortable braking force, the reduced-performance comfortable braking is triggered.

Continuing with reference to FIG. 5A, at block 510, a reduced-performance indicator may be sent to the vehicle control unit. For example, by sending an indicator, the driver is kept informed about the vehicle's current comfortable braking performance, allowing other systems of the vehicle to adjust in accordance with the level of comfortable braking performance. In addition, in some examples, whether to trigger full-performance comfortable braking may be based on whether the current deceleration is greater than the first deceleration threshold and less than the second deceleration threshold. For example, assuming that the first deceleration threshold is 3 m/s², the second deceleration threshold is 5 m/s², and the current deceleration is greater than the first deceleration threshold and less than the second deceleration threshold, it is determined that the reduced-performance comfortable braking may be triggered.

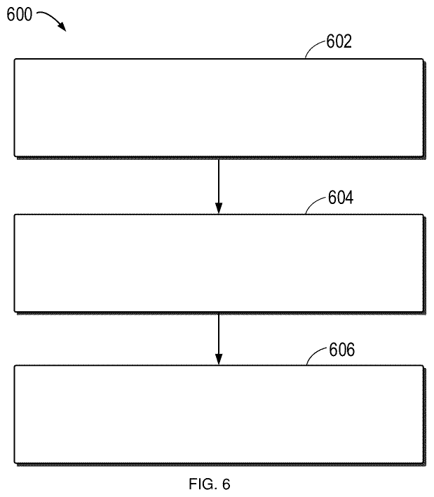

FIG. 6 is a flow chart of a process 600 for determining a regenerative braking force according to examples of the present disclosure. At block 602, the current hydraulic braking force may be obtained. For example, in conjunction with FIG. 1, the control system 110 may obtain the current hydraulic braking force from the hydraulic brake unit 140. In some examples, the control system may obtain the current hydraulic braking force from the vehicle control unit. At block 604, the target regenerative braking force may be determined based on the comfortable braking force and the current hydraulic braking force. In some examples, the target braking force that the driver wants to request may be determined by the opening degree of the brake pedal, and then the comfortable braking force may be determined based on parameters such as the target braking force, vehicle's speed, deceleration, and slope value. For example, if the comfortable braking force may be determined to be 500 N, and the current hydraulic braking force is detected to be 100 N, then the target regenerative braking force may be determined to be 400 N. Since regenerative braking enables energy recovery, increasing the proportion of regenerative braking may enhance the energy recovery efficiency during braking.

At block 606, the actual regenerative braking force may be adjusted based on the braking force offset. For example, if a target regenerative braking force of 400 N is requested from the regenerative braking unit, and the maximum achievable regenerative braking force is 500 N, then the actual regenerative braking force offset is (500 N−400 N)=100 N. It can be seen that although the motor can provide a target regenerative braking force of 500 N, it only needs to provide an actual regenerative braking force of 400 N. When the driver slightly increases the braking request (for example, by increasing the opening degree of the brake pedal), the braking force provided by the regenerative braking force offset may be adjusted to respond quickly, thereby enhancing the response speed of the braking system. When the driver quickly increases the braking request, the braking force offset may be quickly adjusted, and the regenerative braking force and hydraulic braking force may be increased simultaneously to provide a sufficient braking force response to meet the driver's emergency braking needs.

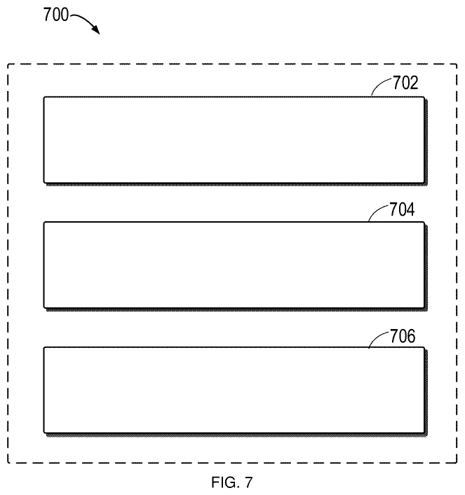

FIG. 7 is a schematic diagram of a device 700 for comfortable braking according to examples of the present disclosure. The device 700 comprises a comfortable braking determination unit 702, configured to determine a comfortable braking force based on an opening degree of a brake pedal of a vehicle. The device 700 further comprises a hydraulic regeneration determination unit 704, configured to determine a hydraulic braking force and a regenerative braking force based on the comfortable braking force. In addition, the device 700 further comprises a comfortable braking control unit 706, configured to perform comfortable braking on the vehicle based on the hydraulic braking force and the regenerative braking force.

In some examples, the comfortable braking determination unit 702 comprises: a target braking determination unit, configured to determine the requested target braking force based on the opening degree of the brake pedal; and a comfortable braking second determination unit, configured to determine the comfortable braking force based on the target braking force, the vehicle's speed, deceleration and slope value.

In some examples, the apparatus 700 further comprises: a regenerative braking adjustment unit, configured to respond upon detecting that the regenerative braking force drops to zero; and a hydraulic braking adjustment unit, configured to increase the hydraulic braking force to be equal to the target braking force.

In some examples, the hydraulic regeneration determination unit 704 comprises: a current hydraulic pressure acquisition unit, configured to acquire a current hydraulic braking force of the vehicle; a target regeneration determination unit, configured to determine a target regenerative braking force based on the comfortable braking force and the current hydraulic braking force; a regenerative braking determination unit, configured to determine the regenerative braking force based on the target regenerative braking force, the vehicle's speed and the motor power; and a hydraulic braking determination unit, configured to determine the hydraulic braking force based on the comfortable braking force and the regenerative braking force.

In some examples, the regenerative braking determination unit comprises: a maximum regeneration determination unit, configured to determine a maximum regenerative braking force based on the speed of the vehicle and the motor power; a regenerative braking second determination unit, configured to respond when the maximum regenerative braking force is greater than the target regenerative braking force, and use the target regenerative braking force as the regenerative braking force; and a regenerative braking third determination unit, configured to respond when the maximum regenerative braking force is less than or equal to the target regenerative braking force and use the maximum regenerative braking force as the regenerative braking force.

In some examples, the regenerative braking determination unit further comprises: a full-performance trigger unit, configured to respond when the current hydraulic braking force is less than the minimum value of the comfortable braking force and trigger the full-performance comfortable braking; a reduced-performance trigger unit, configured to respond when the current hydraulic braking force is greater than the minimum value of the comfortable braking force and less than the requested target braking force and trigger the reduced-performance comfortable braking; and an indicator sending unit, configured to send a performance indicator indicating the comfortable braking performance to the vehicle control unit.

In some examples, the regenerative braking determination unit further comprises: a reduced-performance second trigger unit, configured to respond when deceleration of the vehicle is less than a first deceleration threshold and greater than a second deceleration threshold and trigger the reduced-performance comfortable braking; a full-performance second trigger unit, configured to respond when the deceleration is less than the second deceleration threshold and trigger full-performance comfortable braking; and an indicator second sending unit, configured to send a performance indicator indicating comfortable braking performance to the vehicle control unit.

In some examples, the apparatus 700 further comprises: an actual regeneration monitoring unit, configured to monitor the actual regenerative braking force of the vehicle; a braking difference determination unit, configured to respond when the actual regenerative braking force is less than the regenerative braking force and determine the braking force difference between the actual regenerative braking force and the regenerative braking force; and a hydraulic braking adjustment unit, configured to adjust the hydraulic braking force based on the braking force difference.

In some examples, the apparatus 700 further comprises: a braking offset determination unit, configured to determine a braking force offset of the vehicle; and a vehicle braking control unit, configured to brake the vehicle utilizing the braking force offset, the regenerative braking force and the hydraulic braking force in response to an emergency braking request of the vehicle.

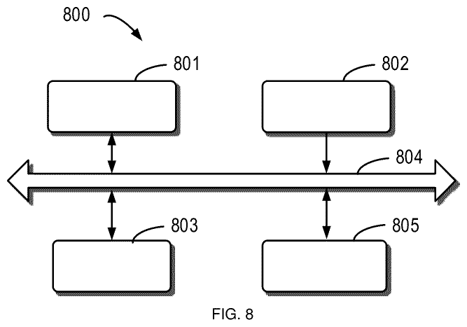

FIG. 8 illustrates a schematic block diagram of an exemplary device 800 that may be used to implement the examples of the present disclosure. As shown, the device 800 comprises a processor 801, which may perform various appropriate actions and processes according to embedded program instructions stored in a read-only memory (ROM) 802 or embedded program instructions in a random-access memory (RAM) 803. Various programs and data required for the operation of the device 800 may also be stored in the RAM 803. The processor 801, the ROM 802, and the RAM 803 are interconnected through a bus 804. An input/output (I/O) interface 805 is also connected to the bus 804.

The various processes and processing described above may be executed by the processor 801. For example, in some examples, it may be implemented as an embedded program tangibly contained in a machine-readable medium. In some examples, part or all of the embedded program may be loaded and/or installed onto the device 800 via the ROM 802. When the embedded program is loaded into the RAM 803 and executed by the processor 801, one or more actions of the method and process described in the present disclosure may be performed.

The machine-readable storage medium may be a tangible device that maintains and stores instructions used to instruct execution devices. The machine-readable storage medium, for example, may be—but is not limited to—an electrical storage device, a magnetic storage device, an optical storage device, an electromagnetic storage device, a semiconductor memory device, or any suitable combination of the above. More specific examples of the machine-readable storage medium (a non-exhaustive list) comprise: random access memory (RAM), read-only memory (ROM), erasable programmable read-only memory (EPROM or flash memory), static random-access memory (SRAM), and any suitable combination of the above. The machine-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The machine-readable program instructions described herein may be downloaded from a machine-readable storage medium to various computing/processing devices, or downloaded to external machines or external storage devices from networks, such as the Internet, a local area network, a wide area network, and/or a wireless network. The networks may comprise copper transmission cables, fiber optic transmissions, wireless transmissions, routers, firewalls, switches, gateway machines and/or edge servers. The network adapter card or network interface in each computing/processing device receives the machine-readable program instructions from the network and forwards the machine-readable program instructions for storage in a machine-readable storage medium of each computing/processing device.

The machine program instructions for performing the operations of the present disclosure may be assembly instructions, instruction set architecture (ISA) instructions, machine instructions, machine-related instructions, microcode, firmware instructions, state-setting data, or source code or object code written in any combination of one or more programming languages, including object-oriented programming languages—such as Smalltalk, C++, etc., as well as conventional procedural programming languages—such as the C language or similar programming languages. The machine-readable program instructions may execute entirely on the user's machine, partly on the user's machine, as a stand-alone software package, partly on the user's machine and partly on a remote machine or entirely on the remote machine or server. Where a remote machine is involved, the remote machine may be connected to the user's machine through any type of network, including a local area network (LAN) or a wide area network (WAN), or may be connected to an external machine (e.g., through the Internet using an Internet service provider). In some examples, the state information of machine-readable program instructions is used to personalize an electronic circuit, such as a programmable logic circuit, a field-programmable gate array (FPGA), or a programmable logic array (PLA), wherein the electronic circuit is able to execute machine-readable program instructions, thereby achieving the various aspects of the present disclosure.

Various aspects of the present disclosure are described herein with reference to flow charts and/or block diagrams depicting the method, device (system), and computer program product according to the examples of the present disclosure. It should be understood that every block in the flow charts and/or block diagrams and the combinations of various blocks in the flow charts and/or block diagrams may be implemented by machine-readable program instructions.

These machine-readable program instructions may be provided to a processing unit of a general-purpose machine, a special-purpose machine, or other programmable data processing devices to produce a machine such that when these instructions are executed by the processing unit of the machine or other programmable data processing devices, a device is generated that implements the functions/actions specified in one or more blocks in the flow charts and/or block diagrams. These machine-readable program instructions may also be stored in a machine-readable storage medium, and these instructions cause the machine, programmable data processing devices, and/or other equipment to work in a specific manner. Therefore, the machine-readable medium storing the instructions comprises a manufactured product that comprises instructions for implementing various aspects of the functions/actions specified in one or more blocks in the flow charts and/or block diagrams.

The machine-readable program instructions may also be loaded onto a machine, other programmable data processing devices, or other equipment so that a series of operational steps are performed on the machine, other programmable data processing apparatus, or other device to produce a machine-implemented process, thereby causing the instructions executed on the machine, other programmable data processing apparatus, or other device to implement the functions/actions specified in one or more blocks in the flowchart and/or block diagram.

The flow charts and block diagrams in the drawings show the system architecture, functions and operations that may be implemented based on the system, method and computer program product according to the plurality of examples of the present disclosure. Regarding this, every block in the flow charts or block diagrams may represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and computer instructions.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The terms used herein are chosen to best explain the principles and practical application of the various examples or the technological improvements in the technology in the market, or allow others of ordinary skill in the art to understand the various examples disclosed herein.

What is claimed is:

1. A method for comfortable braking, comprising:
determining a comfortable braking force based on an opening degree of a brake pedal of a vehicle;
determining a hydraulic braking force and a regenerative braking force based on the comfortable braking force; and
performing comfortable braking on the vehicle based on the hydraulic braking force and the regenerative braking force.

2. The method according to claim 1, wherein determining the comfortable braking force comprises:
determining a requested target braking force based on the opening degree of the brake pedal; and
determining the comfortable braking force based on the target braking force, and the vehicle's speed, deceleration and slope value.

3. The method according to claim 2, further comprising:
responding upon detecting that the regenerative braking force drops to zero; and
increasing the hydraulic braking force to be equal to the target braking force.

4. The method according to claim 1, wherein determining the hydraulic braking force and the regenerative braking force comprises:
acquiring a current hydraulic braking force of the vehicle;
determining a target regenerative braking force based on the comfortable braking force and the current hydraulic braking force;
determining the regenerative braking force based on the target regenerative braking force and the vehicle's speed and motor power; and
determining the hydraulic braking force based on the comfortable braking force and the regenerative braking force.

5. The method according to claim 4, wherein determining the regenerative braking force comprises:
determining a maximum regenerative braking force based on the speed and the motor power of the vehicle;
responding when the maximum regenerative braking force is greater than the target regenerative braking force, and using the target regenerative braking force as the regenerative braking force; and
responding when the maximum regenerative braking force is less than or equal to the target regenerative braking force, and using the maximum regenerative braking force as the regenerative braking force.

6. The method according to claim 5, further comprising:
responding when the current hydraulic braking force is less than the minimum value of the comfortable braking force, triggering full-performance comfortable braking;
responding when the current hydraulic braking force is greater than the minimum value of the comfortable braking force and less than the requested target braking force, triggering reduced-performance comfortable braking; and
sending a performance indicator indicating comfortable braking performance to a vehicle control unit.

7. The method according to claim 5, further comprising:
responding when deceleration of the vehicle is less than a first deceleration threshold and greater than a second deceleration threshold, triggering reduced-performance comfortable braking;
responding when the deceleration is less than the second deceleration threshold, triggering full-performance comfortable braking; and
sending a performance indicator indicating comfortable braking performance to a vehicle control unit.

8. The method according to claim 1, further comprising:
monitoring actual regenerative braking force of the vehicle;
responding when the actual regenerative braking force is less than the regenerative braking force, and determining the braking force difference between the actual regenerative braking force and the regenerative braking force; and
adjusting the hydraulic braking force based on the braking force difference.

9. The method according to claim 1, further comprising:
determining a braking force offset of the vehicle; and
responding to an emergency braking request of the vehicle, braking the vehicle using the braking force offset, the regenerative braking force and the hydraulic braking force.

10. A device for comfortable braking, comprising:
a comfortable braking determination unit configured to determine a comfortable braking force based on an opening degree of a brake pedal of a vehicle;
a hydraulic regeneration determination unit configured to determine a hydraulic braking force and a regenerative braking force based on the comfortable braking force; and
a comfortable braking control unit configured to perform comfortable braking on the vehicle based on the hydraulic braking force and the regenerative braking force.

11. A controller, comprising:
at least one processor, and
a memory, coupled to the at least one processor, and having instructions stored thereon, wherein the instructions, when executed by the at least one processor, cause the controller to perform the method according to claim 1.

12. A computer program product, tangibly stored on a non-transitory computer-readable medium and comprising machine-executable instructions, wherein the machine-executable instructions are used to perform the method according to claim 1.
